(19) United States
(12) Patent Application Publication
(10) Pub. No.: US 2007/0012336 A1
(43) Pub. Date: Jan. 18, 2007

(54) Photomask cleaning using vacuum ultraviolet (VUV) light cleaning

(75) Inventors: Yih-Chen Su, Taichung City (TW); Chih-Cheng Lin, Kaohsiung City (TW); Tung Yaw Kang, Taipei (TW); Hung Chang Hsieh, Hsin-Chu City (TW)

Correspondence Address: DUANE MORRIS LLP;IP DEPARTMENT (TSMC), 30 SOUTH 17TH STREET, PHILADELPHIA, PA, 19103-4196, US

(73) Assignee: Taiwan Semiconductor Manufacturing Co., Ltd., Hsin-Chu (TW)

(21) Appl. No.: 11/392,300

(22) Filed: Mar. 28, 2006

Related U.S. Application Data
(63) Continuation-in-part of application No. 11/184,703, filed on Jul. 18, 2005.

(51) Int. Cl. B08B 3/12; B08B 3/00

(52) U.S. Cl. 134/1; 134/26; 134/28; 134/29

(57) ABSTRACT

A multi-sub-process cleaning procedure cleans phase shift photomasks and other photomasks and Mo-containing surfaces. In one embodiment, vacuum ultraviolet (VUV) light produced by an Xe₂ excimer laser converts oxygen to ozone that is used in a first cleaning operation. The VUV/ozone clean may be followed by a wet SC1 chemical clean and the two-sub-process cleaning procedure reduces phase-shift loss and increases transmission. In another embodiment, the first sub-process may use other means to form a molybdenum oxide on the Mo-containing surface. In another embodiment, the multi-sub-process cleaning operation provides a wet chemical clean such as SC1 or SPM or both, followed by a further chemical or physical treatment such as ozone, baking or electrically ionized water.

This application is a continuation-in-part of U.S. patent application Ser. No. 11/184,703, filed Jul. 18, 2005.

### FIELD OF THE INVENTION

Aspects of the present invention relate, most generally, to semiconductor device manufacturing, and more specifically to cleaning methods for the photomasks used in semiconductor device manufacturing.

### BACKGROUND

In the semiconductor manufacturing industry, cleaning is one of the most important aspects of photomask manufacturing and maintenance because even the smallest contaminating particles may be printable on wafers and such particles can destroy devices. Photomask cleaning requirements are stricter than those for the wafers upon which the devices are formed because the photomasks provide the master image from which all wafer patterning occurs. More difficult challenges are now faced as we enter the 90 nm era with 193 nm DUV lithography and more prominent use of phase shifting mask (PSM) applications. A phase-shifting, or phase-shift mask differs from a conventional photomask as it includes a layer of semi-transparent material featuring a desired refractive index and thickness which is locally added to the mask in order to shift phase of the light passing through the transparent portion of the mask. Phase-shifting increases the resolution of pattern transfer by using destructive interference that prevents photoresist exposure in regions in which it should not be exposed. MoSi or variations of MoSi such as MoSiON are advantageously used as this phase-shifting material. It is therefore critical that the cleaning procedures used to clean phase-shift masks can effectively clean MoSi-based and other phase shift materials.

The cleaning operations used to clean photomasks are needed during the manufacturing process used to produce the photomasks and also to clean finished photomasks that are being used in the production environment. The manufacturing process used to form photomasks includes patterning operations that utilize photoresist materials which must be completely removed before the photomask can be used in the production environment.

As the defect sizes that must be controlled in the manufacturing environment decrease, conventional cleaning methods such as SC1 (NH₄OH/H₂O₂/H₂O) and megasonic hardware cleaning techniques fall short. A shortcoming of such conventional cleaning processes is that they leave particles and other contaminants on the photomask which are printable onto wafers, i.e. semiconductor substrates.

### SUMMARY

Aspects of the present invention includes a method of cleaning a photomask. In one aspect, the method includes providing a photomask, performing a wet chemical clean on the photomask, and performing a physical or dry chemical treatment to farther clean the photomask. A method embodiment may include initially cleaning with ozone generated by vacuum ultraviolet (VIV) light and secondly cleaning with a liquid NH₄OH/H₂O₂/H₂O mixture. Alternatively, the physical or dry chemical treatment may follow the wet chemical clean.

Another aspect of the present invention is a method for cleaning a Mo-containing surface. A method embodiment includes providing a Mo-containing surface, generating MoO₃ on the Mo-containing surface and then cleaning with a liquid NH₄OH/H₂O₂/H₂O mixture.

Another aspect of the present invention is a method for cleaning a photomask comprising providing a photomask, performing a wet chemical clean, the wet chemical clean including at least one of a liquid NH₄OH/H₂O₂/H mixture and a liquid H₂SO₄:H₂O₂ mixture in about a 1:4 ratio, then cleaning the photomask using electrically ionized water.

### BRIEF DESCRIPTION OF THE DRAWING

The embodiments of the present invention are best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like numerals denote like features throughout the specification and drawing.

FIG. 1 provides a number of cross-sectional views that together constitute a process sequence for manufacturing a photomask and which utilizes the cleaning procedure embodiment of the present invention.

FIG. 2 depicts a flowchart of a process to clean a photomask, in accordance with an embodiment of the present invention.

FIG. 3 displays a table showing the mean count of contaminating particles per swath of an inspection location after cleanings conducted in accordance with an embodiment of the present invention.

FIG. 4 graphically illustrates the progressive reduction of defects as described in FIG. 3.

### DETAILED DESCRIPTION

One aspect of the present invention includes the realization that it would be desirable to provide a photomask cleaning operation advantageously suited to cleaning phase-shift and other photomasks and which renders the photomask virtually free of printable contaminants.

Phase-shift and other photomasks require cleaning during the manufacturing processes used to form the masks and also after their manufacture is complete and they are being used in the production environment. The manufacturing process used to form phase-shift and other photomasks includes coating the surface of the photomask with a photoresist material then using a photolithographic process to pattern the photomask. The pattern may be a chrome pattern that is opaque or a pattern in the phase-shift material such as MoSi which is partially transmissive. The embodiments of the present invention include a cleaning procedure that effectively cleans MoSi-based or other phase-shift or other photomask surfaces. In one embodiment, cleaning procedure involves utilizing vacuum ultraviolet (VUV) light to generate ozone which is directed to the surface, and followed by an SC1 (NH₄OH/H₂O₂/H₂O) cleaning process. In another embodiment, a cleaning procedure includes forming MoO₃ on the surface of the Mo-containing layer using various methods. The cleaning procedure effectively removes photoresist and other organic and other contaminants, reduces phase-shift loss and increases transmission. In other exemplary embodiments, the cleaning procedure may be used to clean phase-shift or other photomasks after their manufacture is complete, and between uses when the photomasks are used in the production environment.

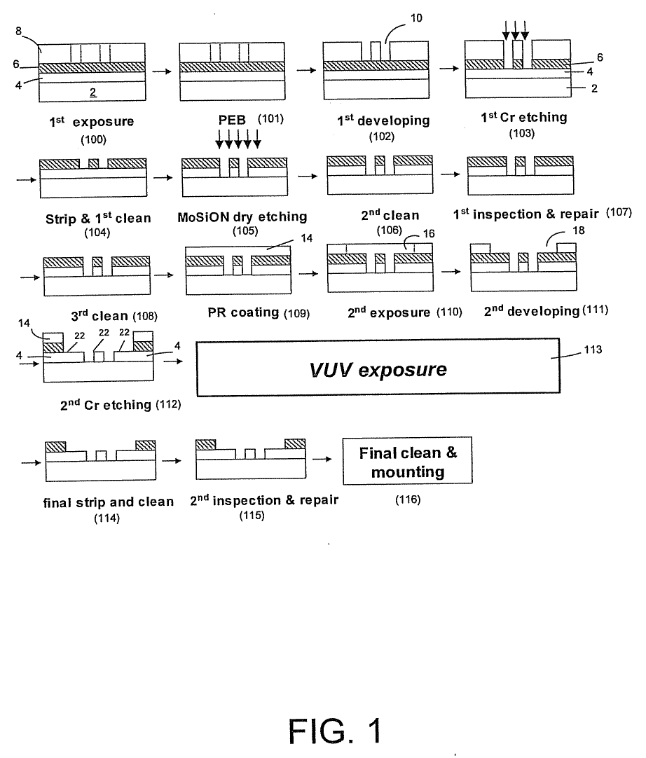

FIG. 1 shows an exemplary sequence of processing operations 100-116 used to form a phase-shift photomask, in accordance with an embodiments of the present invention. At first exposure block 100, photomask substrate 2 which may be quartz or another transparent material, is covered by phase-shift material layer 4. Phase-shift material layer 4 may be a Mo-containing material such as MoSi, MoSiON, or SiN-TiN and may be used to form 193 nm phase-shift masks or 248 nm phase-shift masks. Opaque layer 6, which may advantageously be chrome in an exemplary embodiment, is formed over phase-shift material layer 4 and photoresist pattern 8 is formed over opaque layer 6. Block 101 illustrates a post exposure bake (PEB), block 102 shows the first developing operation to form openings 10 in photoresist pattern 8, and block 103 shows an etching operation used to pattern opaque material 6. The photoresist is stripped in block 104, and a dry etching procedure is carried out in block 105. The dry etching procedure etches phase-shift material layer 4 which may be MoSi, other Mo-containing materials MoSiON or SiN-TiN in various exemplary embodiments. A cleaning operation is carried out at block 106, a first inspection and repair operation may be carried out at block 107 and a third cleaning operation is carried out at block 108. Block 109 shows second photoresist material 14 formed over the photomask structure. The second exposure and second developing operations, blocks 110 and 111 respectively, produce a pattern in second photoresist material 14, for example, opening 16, 18 shown in blocks 110 and 111, respectively. With the pattern in place, a second etching operating is carried out to etch opaque material 6 at block 112. Second photoresist material 14 remains on the photomask structure being fabricated. The structure at block 112 is poised to be cleaned and includes exposed surfaces 22 of phase-shift material layer 4. At this point, the cleaning operation embodiment of the invention is carried out at blocks 113 and 114. The cleaning operations may be followed by a second inspection and repair (block 115) and final clean and mounting (block 116) as in the illustrated embodiment. The cleaning operation embodiment removes particulates and photoresist from the photomask surface.

In addition to finding utility in the illustrated photomask manufacturing sequence, the cleaning operation of the invention may also be used to clean the photomask after it has been manufactured and is being used in a production environment. Furthermore, the cleaning operation embodiment may be used to clean photomasks formed of other materials.

In one embodiment, the first sub-process of the cleaning operation involves the generation of ozone using a vacuum ultraviolet (VUV) light radiation source. In one exemplary embodiment, an excimer Xe₂ laser may be used to generate 172 nm VUV light. The VUV 172 nm light may be produced by a number of fine wire-like discharge plasmas that are generated between two dielectrics. In these microdischarges, electrons excite some Xe atoms. An excited Xe atom then can react with another Xe atom to form an Xe₂ excimer. The discharged plasma excites the gas atoms to instantaneously produce the “excimer” state. The excimer is unstable and decomposes rapidly back into two (2) Xe atoms, releasing a VUV photon at 172 nm. The 172 nm photons can generate atomic oxygen and ozone (O₃) according to the following equations:

$${O}_{1} {\to }^{172 nm} O ( {}^{3} P ) + O ( {}^{1} D )$$

$${O}_{2} + O \to {O}_{3}$$

The ozone is directed or allowed to contact the surface of the photomask to clean the surface. The VUV treatment chamber conditions may include a pressure of about 1 atmosphere or less, and a temperature of about 50-60° C. in one exemplary embodiment, but other temperatures and pressures may be used in other exemplary embodiments. A typical cleaning time may be from 10-30 minutes, but other times may be used. Additionally, it should be pointed out that other wavelengths of radiation may be produced by various techniques and directed to an oxygen source to generate ozone which may then be directed to the photomask surface for cleaning. Various conventional methods may be used to direct the generated ozone to the surface to be cleaned. Applicants have found that this treatment passivates the MoSi surface through oxidation. Applicants believe that this surface oxidation may be the cause for the reduction in phase loss and increase in transmission when the VUV/ozone block is followed by a wet chemical clean according to a cleaning operation of the present invention, when cleaning operation is carried out successively on a photomask or other MoSi surface.

In one embodiment in which the photomask includes a Mo-containing layer such as MoSi or MoSiON, the VUV/ozone oxidation generates a molybdenum oxide such as MoO₃ on the Mo-containing layer. In other exemplary embodiments, other techniques may be used to generate MoO₃ on the Mo-containing material surface. For example, a plasma treatment or chemical vapor deposition (CVD) process capable of generating MoO₃ may be used. Applicants have found that the MoO₃ prevents the MoSi or MoSiON layer from being damaged during a subsequent wet chemical cleaning process such as SC1 clean.

After the VUV ozone cleaning process, an SC1 cleaning follows according to one exemplary embodiment. The SC1 cleaning is a conventional cleaning operation used in semiconductor manufacturing and includes an ammonia hydroxide/hydrogen peroxide/water mixture, which may be 0.25:1:5 and is generally capable of removing particles and some organics from surfaces. The SC1 cleaning operation is typically carried out at a temperature between 40° C. and 70° C. When the VUV/ozone cleaning operation is followed by the SC1 conventional clean, transmission is maximized and particle contamination is minimized. In one advantageous embodiment, when the 172 nm VUV/ozone surface treatment was carried out in conjunction with the SC1 clean, the cleaning sequence provided a reduction in phase loss and transmission increase more than 79% and 70% respectively.

Although described in conjunction with a cleaning operation illustrated in a process sequence of FIG. 1, the cleaning operation may be used at various stages in the fabrication of a phase shift photomask or other surfaces that are Mo-containing materials. For example, the aforedescribed cleaning operation may be used in a process sequence for forming a photomask prior to the introduction of chrome to the photomask.

Another exemplary embodiment of the cleaning operation of the present invention is a two or more sub-process cleaning operation that provides at least one wet chemical cleaning operation followed by a further physical or wet or dry chemical treatment to reduce chemical residue. This exemplary cleaning sequence may be used during the photolithography operations used to produce the photomask or it may be used on a completed photomask being used in the production environment. According to this exemplary embodiment, the first conventional wet-cleaning operation may be an SC1 cleaning operation as described above or it may be a Sulphate/Peroxide Mixture (SPM) cleaning operation, either of the cleaning operations advantageously followed by a rinse. An SPM cleaning solution includes an H₂SO₄:H₂O₂ mixture typically in a 1:4 ratio but other ratios may be used alternatively. The SPM cleaning solution provides a strong oxidizing clean that removes organic materials including photoresist and other contaminants. It may be carried out at various temperatures. In another exemplary embodiment, the initial wet-cleaning operation may include the sequence of an SPM cleaning, rinse, SC1 cleaning and rinse.

At or near the conclusion of the conventional wet-cleaning operation or operation sequence, a further chemical or physical treatment is carried out to clean any residuals that may result from the conventional wet-cleaning operation or operations. In one exemplary embodiment, the further cleaning operation (i.e., treatment) may be a heating or baking procedure that vaporizes any remaining contaminants on the photomask surface. Various temperatures and times may be used. In one exemplary embodiment, the temperature may be at or near the melting temperature of one of the components used in the wet chemical cleaning operation or operations. For example, the bake temperature may be at or near the melting temperature of NH₄OH or at or near the melting point of (NH₄)₂SO₄ but other temperatures may be used in other exemplary embodiments. During the heating or baking operation, the pressure may be controlled at or near vacuum to assist in the vaporization process. The heating or baking procedure may be carried out when the photomask is still wet from the wet chemical clean, or after drying.

In another exemplary embodiment, the further cleaning operation may be the VUV/ozone cleaning operation as described above. The radiation energy and excited oxygen ions assist in the cleaning of defects that may be on the mask surface. In another exemplary embodiment, the further cleaning operation may involve the use of electrically-ionized water. According to this exemplary embodiment, the final rinse of the wet-cleaning operation or sequence may electrically ionize the water used for rinsing using an anode and a cathode and conventional electrochemical techniques. Applicants have found that this urges chemical ions, i.e., contaminating particles, to emigrate from the photomask surface. The further cleaning operation may also other dry or wet physical or chemical cleaning operations.

In still another exemplary embodiment, a three-sub-process photomask cleaning operation may be used. The three-sub-process cleaning operation may involve the VUV/ozone cleaning operation followed by a wet chemical cleaning sequence including one or more of the previously described wet-cleaning operations which is then followed by one or more of the further cleaning operations, i.e., physical or chemical treatments, described above.

After cleaning, the phase-shift photomask may advantageously be used in a lithographic operation to form a semiconductor device pattern on a semiconductor substrate.

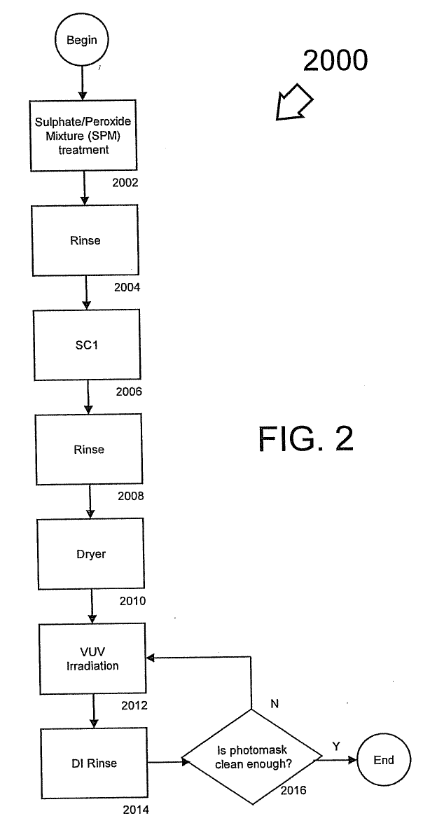

Turning to FIG. 2, a flowchart depicts process 2000, a photomask cleaning method, constructed in accordance with the embodiments of the present invention. In such an embodiment, the photomask receives an initial wet cleaning and cyclic VUV irradiation and de-ionized-water (DI-water) rinses until the number of contaminants on the photomask is sufficiently reduced.

At block 2002, a Sulphate/Peroxide Mixture cleaning operation is performed on the photomask. As described above the SPM cleaning solution includes an H₂SO₄:H₂O₂ mixture typically in a 1:4 ratio but other ratios may be used. The SPM cleaning solution provides a strong oxidizing clean that removes organic materials. The SPM cleaning operations is followed by followed by a rinse, block 2004, and is followed by an SC1 (NH₄OH/H₂O₂/H₂O) cleaning process, block 2006, and another rinse, block 2008. The photomask is dried at block 2010.

The photomask is exposed to vacuum ultraviolet light irradiation, as described above, block 2012. The VUV light generates ozone, which cleans the surface of the photomask. As previously discussed, a number of different temperatures and wavelengths of radiation may be used during such an operation. A subsequent de-ionized water rinse is applied at block 2014, washing way contaminants loosened by the VUV operation. At decision block 2016, a determination is made on whether the resulting photomask is sufficiently cleaned. The determination at block 2016 may be made by determining if the cleaning removes contaminates to a threshold amount. The threshold may be determined in advance, and may vary depending upon the photomask application. If the amount of contaminants is less than the threshold amount, process 2000 ends; if not, the process flow returns to block 2012 and the VUV irradiation and DI rinse are repeated until the cleanliness requirement is satisfied.

It is understood, by those known in the art, that embodiments may include any number of wet cleaning operations may be performed prior to the vacuum ultraviolet light irradiation operations.

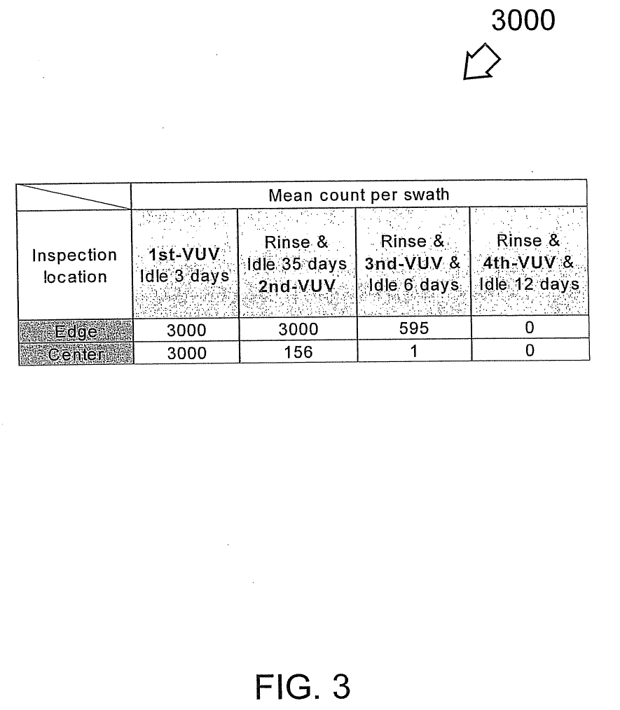

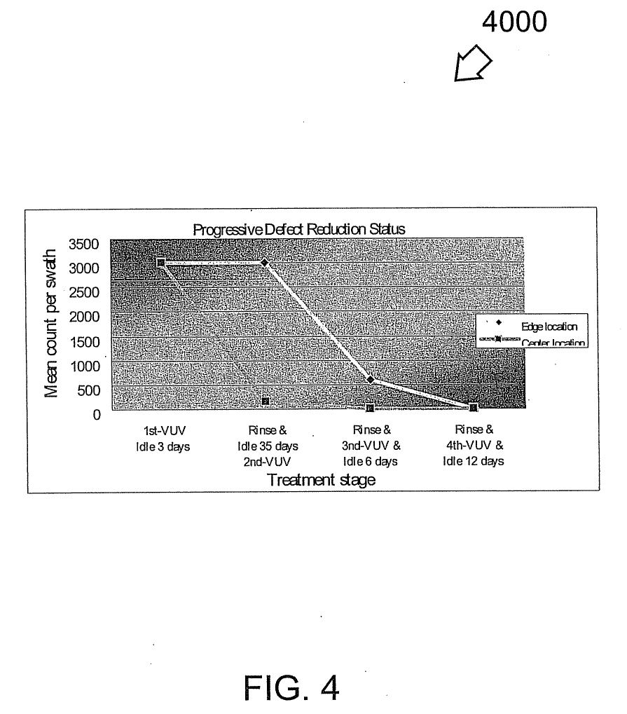

Turning to FIG. 3, a table depicts the mean counts per swath at two inspection locations, after a first, second, third, and fourth VUV treatment, conducted in accordance with the embodiments of the present invention. In the results shown, a photomask was inspected at an edge and a center locations for contaminating particles. The inspection stops whenever the mean count per swath exceeds 3000 contaminating particles. Thus, at an edge location, the number of contaminating particles exceeds 3000 for the first and second VUV treatments, declining to 595 counts and zero after the third and fourth treatments, respectively. In contrast, at the center inspection location, where a greater amount of ozone results from the treatment, the number of contaminating particles drops even more dramatically, from over 3000 at the first treatment, down to 156, one, and finally zero contaminating particles after the second, third, and fourth treatments. The counts of FIG. 3. can be graphically seen in FIG. 4; as shown, a dramatic decrease in contaminating particles results from cyclical VUV treatments, as conducted by embodiments of the present invention.

The preceding merely illustrates the principles of the invention. It will thus be appreciated that those skilled in the art will be able to devise various arrangements which, although not explicitly described or shown herein, embody the principles of the invention and are included within its spirit and scope. For example, other techniques may be used to generate the ozone or to produce MoO₃ on the Mo-containing material surface. Furthermore, the cleaning operation may be used to clean attenuated (MoSi-based) PSM's, chrome masks, alternating (Cr-based) PSM's, BIM's (binary masks consisting of Cr-based films and quartz) and other photomasks.

Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to, encompass both structural and functional equivalents thereof. Additionally, it is intended that such equivalents include both currently known equivalents and equivalents developed in the future, i.e., any elements developed that perform the same function, regardless of structure.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for cleaning a photomask comprising:
wet chemical cleaning the photomask; and
ozone cleaning the photomask with ozone generated through vacuum ultraviolet (VUV) light.

2. The method of claim 1 the wet chemical clean is performed with a liquid NH₄OH/H₂O₂/H₂O or mixture.

3. The method as in claim 2, wherein the photomask includes a Mo-containing surface and the ozone cleaning includes generating MoO₃ on the Mo-containing surface.

4. The method as in claim 3, further comprising:
repeating the ozone cleaning.

5. The method as in claim 4, wherein the repeating is continued until a cleanliness threshold is satisfied.

6. The method as in claim 5, wherein the ozone cleaning includes using an Xe₂ excimer laser to produce the VUV light.

7. The method as in claim 5, wherein the ozone cleaning includes the vacuum ultraviolet (VUV) light including a wavelength of 172 nm.

8. The method as in claim 5, wherein the ozone cleaning takes place for about 30 minutes and at a pressure below 1 atmosphere.

9. The method as in claim 5, wherein the wet chemical cleaning takes place prior to the ozone cleaning.

10. The method as in claim 9, wherein the ozone cleaning comprises heating the photomask while the photomask is still wet from the wet chemical cleaning.

11. The method as in claim 9, wherein the wet chemical cleaning includes cleaning the photomask in a cleaning solution composed of a liquid H₂SO4:H₂O₂ mixture in about a 1:4 ratio; rinsing, cleaning the photomask with a liquid NH₄OH/H₂O₂/H₂O mixture; then further rinsing.

12. The method as in claim 9, wherein the ozone cleaning includes the vacuum ultraviolet (VUV) light including a wavelength of 172 nm.

13. The method as in claim 1, wherein the photomask is used to pattern semiconductor substrates.

14. The method as in claim 1, wherein the wet chemical cleaning and ozone cleaning removes photoresist from the photomask.

15. The method as in claim 14, further comprising using the photoresist to form a pattern over a chrome layer formed over a MoSi surface of the photomask, and etching the chrome layer using the pattern prior to the cleaning and the performing.

16. A method for cleaning a photomask comprising:
wet chemical cleaning the photomask, the wet chemical clean including at least one of a liquid NH₄OH/H₂O₂/H₂O mixture and a liquid H₂SO₄:H₂O₂ mixture; and
rinsing the photomask using electrically ionized water;
ozone cleaning the photomask with ozone generated by vacuum ultraviolet (VUV) light.

17. The method as in claim 16, wherein the liquid H₂SO₄:H₂O₂ mixture is in about a 1:4 ratio.

18. The method as in claim 16, wherein the cleaning the photomask using electrically ionized water occurs during a rinse operation following the wet chemical cleaning and includes an anode and cathode that electrically ionize the water and urges migration of chemical ions from a surface of the photomask.

19. The method as in claim 16, wherein the cleaning using electrically ionized water comprises a final rinsing operation that follows the wet chemical cleaning and the wet chemical cleaning comprises a sequence of: cleaning with a liquid H₂SO₄:H₂O₂ mixture; rinsing in water; and cleaning with a liquid NH₄OH/H₂O₂/H₂O solution.

20. A method for cleaning a photomask comprising:
ozone cleaning the photomask with ozone generated by vacuum ultraviolet (VUV) light; and
wet cleaning the photomask with a liquid NH₄OH/H₂O₂/H₂O solution.
